(19) United States
(12) Patent Application Publication
(10) Pub. No.: US 2016/0298395 A1
(43) Pub. Date: Oct. 13, 2016

(54) QUICK CONNECT APPARATUS AND METHOD

(71) Applicant: KLX ENERGY SERVICES LLC, Houston, TX (US)

(72) Inventor: Toby Scott Baudoin, Rayne, LA (US)

(21) Appl. No.: 15/094,054

(22) Filed: Apr. 8, 2016

Related U.S. Application Data
(60) Provisional application No. 62/144,693, filed on Apr. 8, 2015.

(51) Int. Cl. E21B 17/046; F16L 37/252

(52) U.S. Cl. CPC E21B 17/046; F16L 37/252

(57) ABSTRACT

A method for assembly of a device is disclosed. The device comprises a quick connect apparatus that includes a first member having a male locking profile on an outer surface and a second member having a female locking profile on an inner surface. The method includes stabbing the second member onto the first member to fully seat the first member within the second member, rotating the second member relative to the first member to lock the male locking profile to the female locking profile, and engaging a second locking mechanism to restrict further rotation of the second member relative to the first member.

### CROSS REFERENCES TO RELATED APPLICATIONS

The present application claims the benefit of U.S. Provisional Application No. 62/144,693, entitled “QUICK CONNECT APPARATUS AND METHOD,” and filed on Apr. 8, 2015, which is incorporated herein by reference in its entirety.

### FIELD OF THE DISCLOSURE

The present disclosure generally relates to downhole equipment for oil and gas wells and, more particularly, a method and apparatus for quick non-threaded connection of various elements of a downhole mud string.

### BACKGROUND

During the drilling, work over, or plug and abandonment of oil and gas producing wellbores, a variety of downhole tools may be attached to a pipe or coiled tubing string used to perform various functions within the wellbore. Assembly and maintenance of these downhole tools pose significant safety hazards to operators when a downhole tool string must be often assembled several feet above ground level. This is a time consuming process, and often presents dangerous conditions for the operators as there is a chance that standard wrenches and tongs often used for assembly and maintenance may slip and fall, causing injury or even death.

### DRAWINGS

While the appended claims set forth the features of the present techniques which may be best understood from the following detailed description taken in conjunction with the accompanying drawings of which:

FIG. 1 is a longitudinal cross-section of the apparatus configured according to an embodiment.

FIG. 2 is a side view of the apparatus configured according to an embodiment.

FIG. 3 is an isometric view of a top sub showing the male locking profile configured according to an embodiment.

FIG. 4 is a longitudinal cross-section view of the bottom sub, showing the female locking profile, configured according to an embodiment.

FIG. 5 is a longitudinal cross-section view of the apparatus with lock screws engaged, according to an embodiment.

FIG. 6 is a cross-sectional view of an apparatus, configured according to a second embodiment.

FIG. 7 is a side view of a second embodiment of the top sub.

FIG. 8 is a side view of a second embodiment of the bottom sub.

FIG. 9 is a side view of a third embodiment of the top sub.

FIG. 10 is a side view of an apparatus connecting a coiled tubing or pipe string to a bottom hole assembly, according to an embodiment.

### DETAILED DESCRIPTION

The following discussion is directed to various exemplary embodiments. However, one possessing ordinary skill in the art will understand that the examples disclosed herein have broad application, and that the discussion of any embodiment is meant only be exemplary of that embodiment, and not intended to suggest that the scope of the disclosure, including claims, is limited to that embodiment.

Certain terms are used throughout the following description to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In an embodiment, the method for assembly of a downhole tool string is disclosed. The downhole tool string comprises a quick connect apparatus that includes a first member having a male locking profile on an outer surface and a second member having a female locking profile on an inner surface. The method includes stabbing the second member onto the first member to fully seat the first member within the second member, rotating the second member relative to the first member to lock the male locking profile to the female locking profile, and engaging a second locking mechanism to restrict further rotation of the second member relative to the first member.

According to an embodiment, the apparatus includes a first member having a male locking profile on an outer surface, a second member having a female locking profile on an inner surface. The male locking profile is configured to engage the female locking profile when the first member is rotated within the second member, and a second locking mechanism is configured to secure the first member to the second member to prevent additional rotation of the second member relative to the first member.

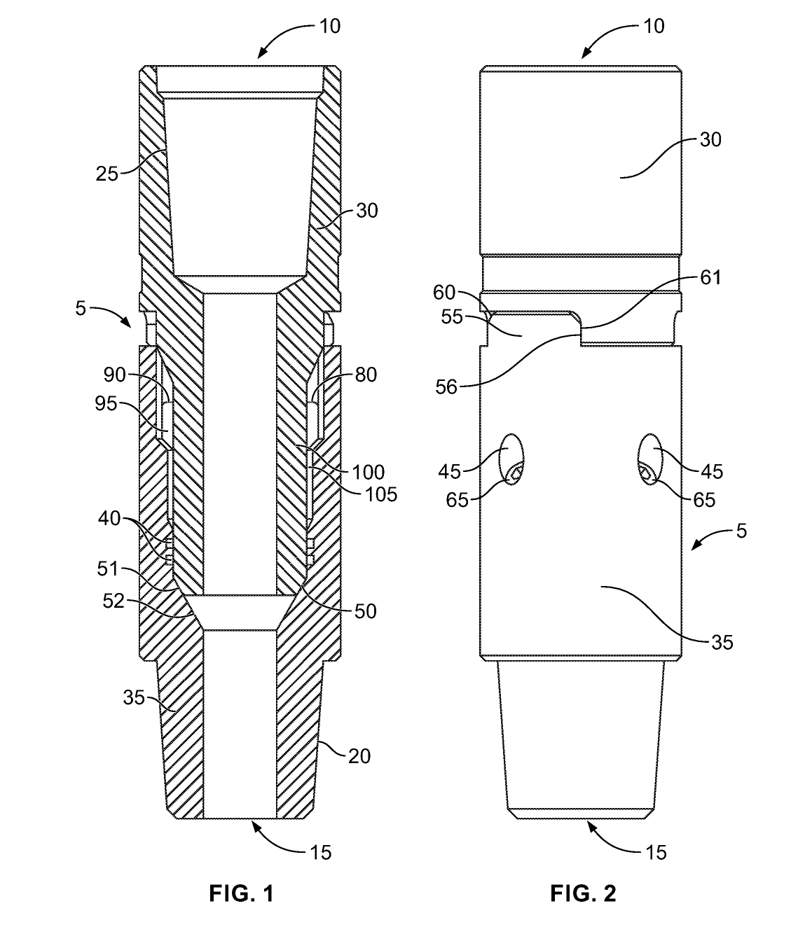

Turning to FIG. 1, an apparatus 5 configured according to an embodiment is shown. The apparatus 5 provides a means for quickly, easily, and safely connecting a downhole tool to a pipe or coiled tubing tool string. The upper end 10 of the apparatus 5 may be connected to the coiled tubing or pipe string by a threaded connection 25, while the lower end 15 may be connected to the downhole tool string by a threaded connection 20. In this configuration, the components of the apparatus 5 are coupled together, as they would be during normal operation in the wellbore.

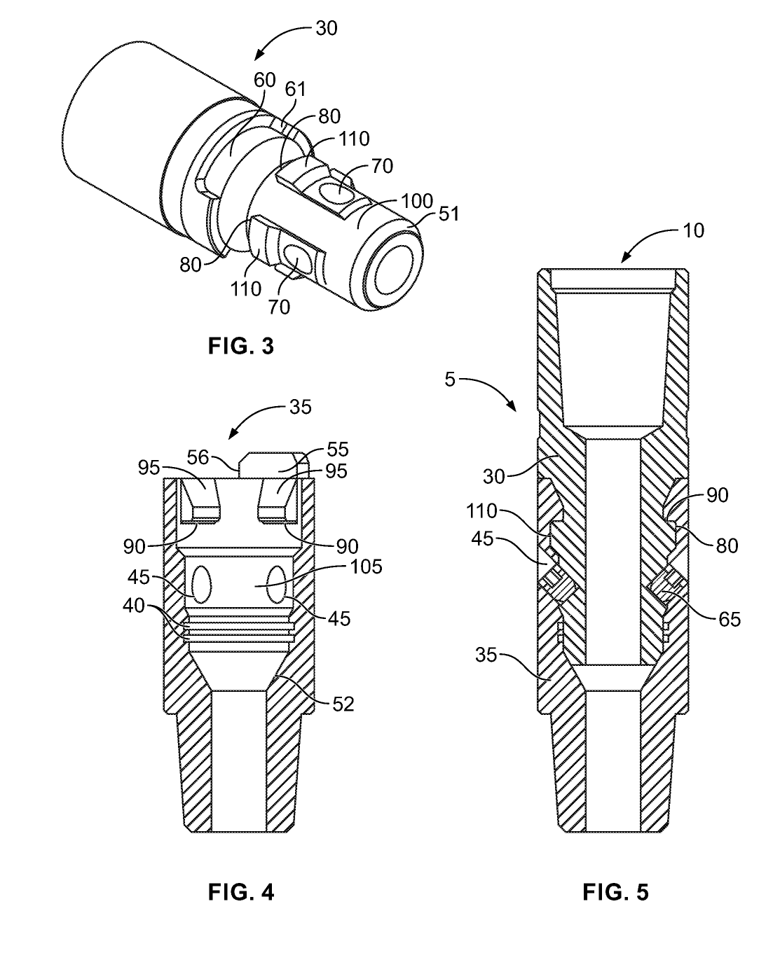

In operation of the apparatus 5, an operator may threadedly connect a bottom sub 35 to the upper end of the tool string by a threaded connection 20, while a top sub 30 may be threadedly connected to the coiled tubing or pipe string by threaded connection 25. As will be discussed later with reference to FIGS. 2 and 3, the bottom sub 35 includes a female locking 105 and the top sub 30 includes a male locking profile 100. In operation, the female locking profile 105 of the bottom sub 35 may be raised up and stabbed onto the male profile 100 of the top sub 30, so that top sub 30 fully seats against the bottom sub 35. According to an embodiment, the bottom sub 35 is then rotated by a preset angle relative to top sub 30, such that shoulders 90 of the bottom sub 35 may rest against shoulders 80 of top sub 30. In an embodiment, the bottom sub 35 is configured to be rotated by an angle of 45° relative to the top sub 30.

In this position, a plurality of lock screws 65, seen more clearly in FIG. 2, are aligned with holes 45 provided on the bottom sub 35, and are tightened into a plurality of pockets 70 of the top sub 30. As can be seen more clearly in FIG. 3, the above configuration prevents the top sub 30 and bottom sub 35 from rotating out of position, as well as draws them together. A person skilled in the art will understand that the lock screws 65 may be replaced by threaded pins, pins and snap rings, a combination thereof, or any other means of preventing rotation and/or providing a secondary means of keeping top sub 30 connected to bottom sub 35. Once the top sub 30 and the bottom sub 35 are fully mated, O-ring seals 40 and face seals 50, formed by contact between a surface 51 of the top sub 30, and a surface 52 of the bottom sub 35, prevent the loss of fluid from the apparatus 5 into the wellbore.

Turning now to FIG. 2, an outside view of apparatus 5 is illustrated. The bottom sub 35 includes a castle 55 and pockets 60 that are configured to prevent the bottom sub 35 from being over rotated within the top sub 30. This ensures that lock screws 65 are precisely aligned with their corresponding holes 45 provided on the bottom sub 35 and the pockets 70 of the top sub 30 (shown in FIG. 3). In addition, the castles 55 and the pockets 60 serve as a means of torque transmission through the apparatus 5 according to an exemplary embodiment.

FIG. 3 is an outside view of top sub 30 showing the male locking profile 100. When the top sub 30 and the bottom sub 35 are engaged, the shoulders 80 on lugs 110 of the top sub 30 make contact with the shoulders 90 on the lugs 95 within the bottom sub 35 (as can be seen in FIG. 4), and pockets 70 of the top sub 30 are aligned with the holes 45 provided on the bottom sub 35. According to an embodiment, the plurality of lock screws 65 are then inserted and tightened, which causes the bottoms sub 35 to be drawn tightly to the top sub 30. In this position, the surfaces 56 of the castles 55 on the bottom sub 35 are brought in contact with the walls 61 of the pockets 60 on the top sub 30.

FIG. 4 shows a cross-sectional view of the bottom sub 35, comprising the female locking profile 105. According to an embodiment, the upper end of the bottom sub 35 includes a plurality of are lugs 95 that mesh with the lugs 110 of top sub 30 as shown in FIG. 3. Additionally, the bottom sub 35 includes the O-ring seals 40, which prevent the leakage of fluid into the wellbore, as well as surface 52 which forms a face seal 50 when in contact with the surface 51 of top sub 30. As will be appreciated by persons skilled in the art, other types of seals, generally made from elastomeric materials, may be used in lieu of the O-ring seals.

Once lock screws 65 have been engaged through the plurality of holes (45) provided on the bottom sub 35 and into the pockets 70 of the top sub 30, as shown in FIG. 5, the two components of apparatus (5) are drawn together, so that the shoulders 90 of the bottom sub 35 are closely aligned with the shoulders 80 of the top sub 30, and cannot rotate and separate from one another.

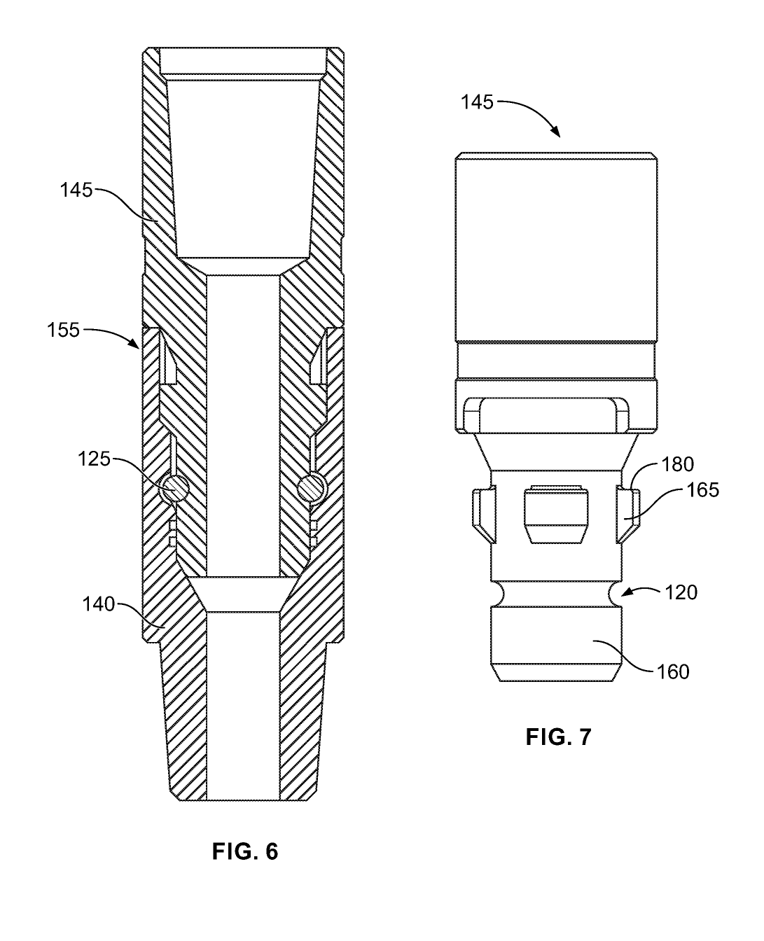

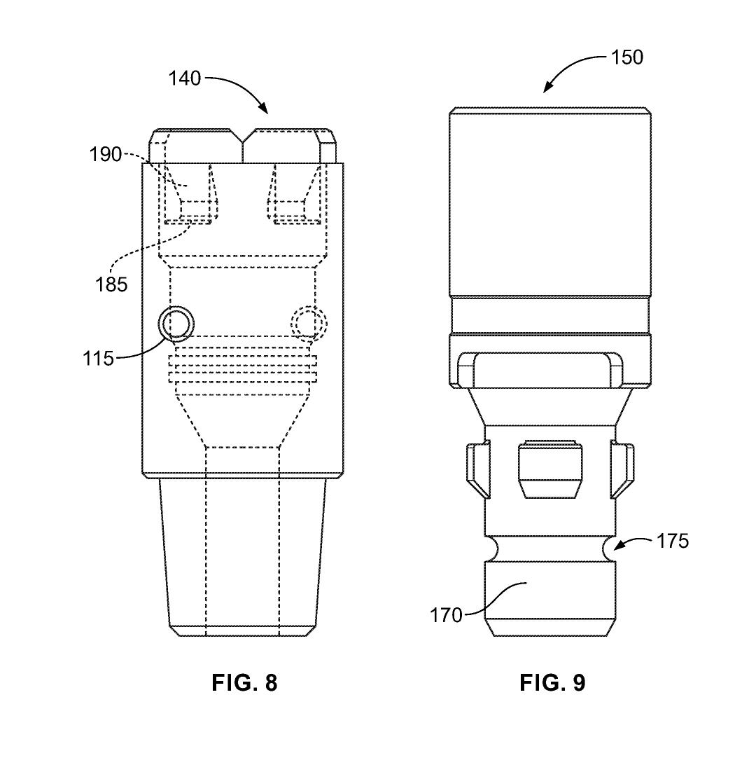

FIGS. 6-8 disclose an alternative embodiment of the apparatus 5. Apparatus 155 comprises a top sub 145 that engages with a bottom sub 140, configured according to another embodiment. The top sub 145 is configured to include one or more grooves 120 on a lower end of the male locking profile 160, as better seen in FIG. 7. The bottom sub 140, better seen in FIG. 8, comprises a number of pin holes 115 that align with grooves 120 of the top sub 145 upon engagement of the bottom sub 140 to the top sub 145. Referring to FIG. 6, the bottom sub 140 is stabbed onto the top sub 145, and then rotated a predetermined angle relative to the top sub 145. According to one example configuration, the bottom sub 140 is rotated by an angle of 45° relative to the top sub 145, so that the shoulders 180 of the lugs 165 on the top sub 145 are in contact with the shoulders 185 of the lugs 190 on the bottom sub 140. Persons skilled in the art will appreciate that the angle of rotation of the bottom sub 140 relative to the top sub 145 may be set to be any appropriate angle to engage the male locking profile and the female locking profile.

A plurality of pins 125 are then inserted through the pin holes 115, which provide a means of retention between the bottom sub 140 and the top sub 145, as seen in FIG. 6. A person skilled in the art will understand that the pins 125 may be any form of dowel pin, square pin, set screw, or any object or combination that will provide a means of retention between the bottom sub 140 and the top sub 145.

FIG. 9 illustrates a top sub configured according to another embodiment of the apparatus 5. Apparatus 155 may comprise a top sub 150, as seen in FIG. 9, according to an embodiment. Top sub 150 includes a number of transverse slots 175 located on a lower end of the male locking profile 170. Upon full engagement of the bottom sub 140 onto the top sub 150, a plurality of pins 125 may be inserted through pin holes 115 of the bottom sub 140 and through the transverse slots 175 of the top sub 150, which provide a means of retention between top sub 150 and the bottom sub 140, as well as provides a secondary means for torque transmission through apparatus 155, according to an embodiment.

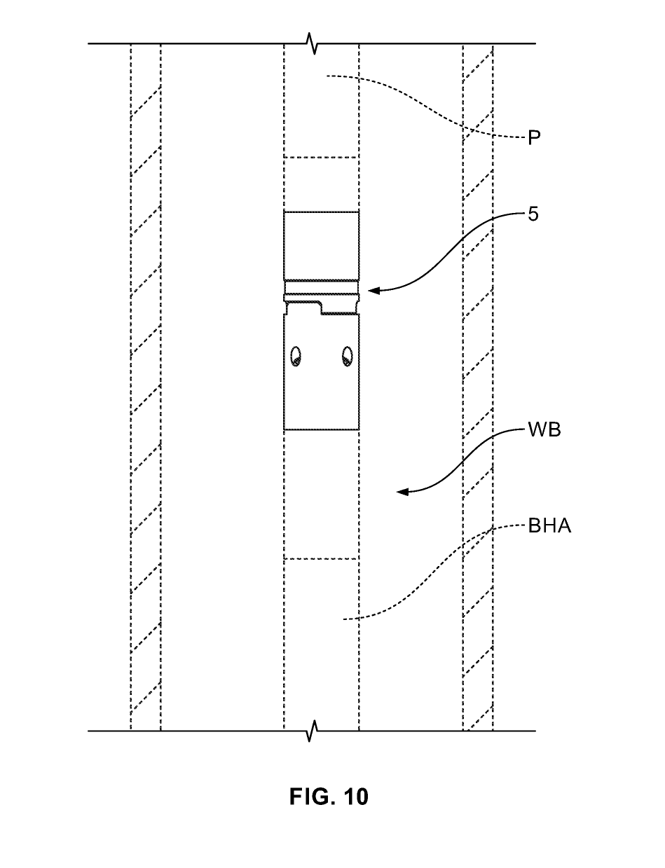

FIG. 10 shows the apparatus 5 connected to a pipe string P on its upper end and a bottom hole assembly (BHA) on its lower end, according to an exemplary embodiment. In this view, apparatus 5 may be configured for normal operation and is shown as being inserted into a wellbore (WB).

A person skilled in the art will appreciate that any number of combinations of the top sub and bottom sub structures discussed above with reference to apparatuses 5 and 155 may be used. For instance, according to other embodiments, the bottom sub may be configured to include the male locking profile and the top sub may be configured to include the female locking profile. Moreover, any number of pins 125 may be used to provide a secondary means of retention and/or torque transmission in conjunction with lock screws 65, according to an embodiment. Apparatus 5, although shown between the pipe string and BHA, may be used between components of a tool string. The top sub 30 may be threadedly attached to the lower end of one component within the tool string and the bottom sub 35 may be threadedly attached to the upper end of a second component of the tool string.

Apparatus 5, 155 therefore creates a safe and easy way for the two components of the tool string to be attached and detached quickly without the need for pipe wrenches or tongs. This is especially important when operators must join two components while elevated above the ground or rig floor. In coil tubing applications, the use of this apparatus eliminates the need for tongs, pipe wrenches, chain hoist, and etc., while working from a man basket on a man lift, elevated some height above the ground.

Although the disclosure above refers to the application of the apparatus 5, 155 in the context of a downhole mud motor, a person skilled in the art will understand that the apparatus 5, 155 may be used in various other systems where different components need to be assembled in an efficient and safe manner. For instance, according to an embodiment, the apparatus 5, 155 is configured to be used in a pipeline cleaning unit. In another exemplary embodiment, the apparatus 5, 155 is configured to be used in a heat exchanger cleaning unit.

For the purposes of promoting an understanding of the principles of the disclosure, reference has been made to the embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art. The particular implementations shown and described herein are illustrative examples and are not intended to otherwise limit the scope of the disclosure in any way.

The steps of all methods described herein are performable in any suitable order unless otherwise indicated herein or otherwise clearly contradicted by context. The use of any and all examples, or exemplary language (e.g., “such as”) provided herein, is intended merely to better illuminate the disclosure and does not pose a limitation on scope unless otherwise claimed. Numerous modifications and adaptations will be readily apparent to those skilled in this art without departing from the spirit and scope of the disclosure.

It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another.

We claim:

1. An apparatus comprising:
a first member having a male locking profile on an outer surface; and
a second member having a female locking profile on an inner surface; wherein
the male locking profile is configured to engage the female locking profile when the first member is rotated within the second member.

2. The apparatus of claim 1, further comprising:
a second locking mechanism configured to secure the first member to the second member to prevent additional rotation of the second member when the male locking profile and the female locking profile are engaged.

3. The apparatus of claim 2, wherein
the first member includes a plurality of pockets;
the second member includes a plurality of holes configured to be aligned with the plurality of pockets on the first member when the first member is rotated within the second member; and
the second locking mechanism comprises a plurality of lock screws configured to be engaged through the plurality of holes included on the second member and into the plurality of pockets included on the first member.

4. The apparatus of claim 2, wherein
the outer surface of the first member includes a plurality of pockets; and
the second locking mechanism comprises a plurality of threaded pins configured to be engaged through the plurality of holes included on the second member and into the plurality of pockets included on the first member.

5. The apparatus of claim 1, further comprising:
the first member being connected to a coiled tubing or pipe string via a threaded connection; and
the second member being connected to a downhole tool string via a threaded connection.

6. The apparatus of claim 1, wherein
the male locking profile comprises a plurality of lugs positioned on the outside surface of the first member; and
the female locking profile comprises a plurality of lugs positioned on the inner surface of the second member.

7. The apparatus of claim 6, wherein the rotation of the first member within the second member is based on plurality of lugs positioned on the outside surface of the first member and the plurality of lugs positioned on the inner surface of the second member.

8. The apparatus of claim 1, wherein
the first member and the second member each includes a respective shoulder; and
the shoulder of the second member is configured to rest against the shoulder of the first member when the first member is rotated within the second member.

9. The apparatus of claim 1, wherein
the first member includes a plurality of grooves on a lower portion of the male locking profile;
the second member includes a plurality of pin holes configured to be aligned to the plurality of grooves when the second member is engaged with the first member; and
the apparatus further comprises a plurality of pins configured to be inserted through the plurality of pin holes and through the plurality of grooves to secure the second member relative to the first member.

10. The apparatus of claim 1, wherein
the first member includes a plurality of transverse slots positioned on a lower portion of the male locking profile;
the second member includes a plurality of pin holes configured to be aligned to the plurality of transverse slots when the second member is engaged with the first member; and
the apparatus further comprises a plurality of pins configured to be inserted through the plurality of pin holes and through the transverse slots to secure the second member relative to the first member.

11. An apparatus according to claim 1, wherein
the first member includes the male locking profile on the outer surface; and
the second member includes the female locking profile on the inner surface; wherein
the male locking profile is configured to engage the female locking profile when the first member is rotated within the second member.

12. A method for assembly of a downhole tool string, the downhole tool string comprising a first member having a male locking profile on an outer surface and a second member having a female locking profile on an inner surface, the method comprising:
stabbing the second member onto the first member to fully seat the first member within the second member; and
rotating the second member relative to the first member to lock the male locking profile to the female locking profile.

13. The method of claim 12 further comprising:
engaging a second locking mechanism to restrict additional rotation of the second member relative to the first member.

14. The method of claim 13, wherein
the first member includes a plurality of pockets;
the second member includes a plurality of holes configured to be aligned with the plurality of pockets on the first member when the first member is rotated within the second member; and
engaging the second locking mechanism comprises inserting a plurality of lock screws through the plurality of holes included on the second member and into the plurality of pockets included on the first member.

15. The method of claim 13, wherein
the outer surface of the first member includes a plurality of pockets; and
the second locking mechanism comprises a plurality of threaded pins configured to be engaged through the plurality of holes included on the second member and into the plurality of pockets included on the first member.

16. The method of claim 12, further comprising:
connecting the first member to a coiled tubing or pipe string via a threaded connection; and
connecting the second member to a downhole tool string via a threaded connection.

17. The method of claim 12, wherein
the male locking profile comprises a plurality of lugs positioned on the outside surface of the first member; and
the female locking profile comprises a plurality of lugs positioned on the inner surface of the second member.

18. The method of claim 12, wherein the male locking profile engages the female locking profile when the second member is rotated by an angle of 45° relative to the first member.

19. The method of claim 12, wherein
the first member and the second member each includes a respective shoulder; and
the shoulder of the second member rests against the shoulder of the first member when the second member is rotated relative to the first member.

20. The method of claim 12, wherein
the first member includes a plurality of grooves on a lower portion of the male locking profile;
the second member includes a plurality of pin holes configured to be aligned to the plurality of grooves when the second member is engaged with the first member; and
the method further comprises inserting a plurality of pins through the plurality of pin holes and through the plurality of grooves to secure the second member relative to the first member.

21. The method of claim 12, wherein
the first member includes a plurality of transverse slots positioned on a lower portion of the male locking profile;
the second member includes a plurality of pin holes configured to be aligned to the plurality of transverse slots when the second member is engaged with the first member; and
the method further comprises inserting a plurality of pins through the plurality of pin holes and through the transverse slots to secure the second member relative to the first member.

22. The method of claim 12, wherein
the first member includes the female locking profile on the inner surface; and
the second member includes the male locking profile on the outer surface.

23. The apparatus of claim 9, wherein the plurality of pins includes at least one of dowel pins, square pins, and set screws.

24. The apparatus of claim 10, wherein the plurality of pins includes at least one of dowel pins, square pins, and set screws.

25. A method for assembly of an apparatus, the apparatus comprising a first member having a male locking profile on an outer surface and a second member having a female locking profile on an inner surface, the method comprising:
stabbing the second member onto the first member to fully seat the first member within the second member;
rotating the second member relative to the first member to lock the male locking profile to the female locking profile; and
engaging a second locking mechanism to restrict additional rotation of the second member relative to the first member subsequent to the male locking profile locking to the female locking profile.

26. An apparatus comprising:
a first member having a first shoulder and a plurality of pockets provided on an outer surface;
a second member having a second shoulder and a plurality of holes positioned on an inner surface, wherein the first shoulder is configured to contact and rest against the second shoulder when the first member is rotated within the second member to engage a first locking mechanism; and
a plurality of pins configured to be inserted through the plurality of pockets provided on the outer surface of the first member and into the plurality of holes of the second member to engage a second locking mechanism.

27. A method for assembly of a device via an apparatus, the device including a first portion and a second portion, the apparatus comprising a first member having a female locking profile on an inner surface and a second member having a male locking profile on an outer surface, the first and second members each having a respective first and second ends, the method comprising:
connecting the first portion of the device to the first end of the first member;
connecting the second portion of the device to the second end of the second member;
stabbing the first end of the second member onto the second end of the first member to fully seat the first member within the second member;
rotating the second member relative to the first member to lock the male locking profile to the female locking profile; and
engaging a second locking mechanism to restrict additional rotation of the second member relative to the first member subsequent to the male locking profile locking to the female locking profile.

28. The method according to claim 27, wherein the device is at least one of a downhole mud motor unit, a pipeline cleaning unit, and a heat exchanger cleaning unit.

29. The method according to claim 27, wherein
connecting the first portion of the device to the first end of the first member comprises providing a threaded connection between the first portion of the device to the first end of the first member; and
connecting the second portion of the device to the second end of the second member comprises providing a threaded connection between connecting the second portion of the device to the second end of the second member.

30. The method according to claim 27, wherein
connecting the first portion of the device to the first end of the first member comprises welding the first portion of the device to the first end of the first member; and
connecting the second portion of the device to the second end of the second member comprises welding the second portion of the device to the second end of the second member.
